(19) United States
(12) Patent Application Publication
(10) Pub. No.: US 2017/0327379 A1
(43) Pub. Date: Nov. 16, 2017

(54) Systems And Methods For Preparing Monolayer, Bi-Layer, and Multi-Layer Graphene From Carbon Sources

(71) Applicant: Universal Evergreen Elements, Inc., Santa Ana, CA (US)

(72) Inventors: Dilip Ghimire, Minot, ND (US); Smithie Chi Lu, Van Nuys, CA (US)

(73) Assignee: Universal Evergreen Element, Inc., Santa Ana, CA (US)

(21) Appl. No.: 15/593,132

(22) Filed: May 11, 2017

Related U.S. Application Data
(60) Provisional application No. 62/334,995, filed on May 11, 2016.

(51) Int. Cl. C01B 32/184; C01B 32/194

(52) U.S. Cl. CPC C01B 32/184; C01B 32/194; C01P 2004/60

(57) ABSTRACT

A method for making graphene comprising the steps of reacting a catalyst with a plurality of source carbon solids; creating a graphene precursor from the reaction of the catalyst with the plurality of source carbon solids; pyrolyzing the graphene precursor; and extracting graphene from the pyrolyzed graphene precursor. Creating a graphene precursor comprises the steps of creating a solution comprising deionized water and the catalyst; reacting the catalyst with the plurality of source carbon solids by mixing the plurality of source carbon solids into the solution comprising deionized water and the catalyst; heating the solution; and stirring the heated mixture until substantially all liquid has evaporated. Pyrolyzing the graphene precursor is done by placing the graphene precursor in a furnace; creating an un-oxidizing environment within the furnace; heating the furnace; and annealing the graphene precursor.

### CROSS-REFERENCE TO RELATED APPLICATION(S)

The present application claims priority to U.S. Provisional Patent Application No. 62/334,995 filed on May 11, 2016, entitled “SYSTEMS, METHODS FOR PREPARATION OF MONO LAYER, BI LAYER AND MULTI-LAYER GRAPHENE FROM SOLID CARBON SOURCES” the entire disclosure of which is incorporated by reference herein.

### BACKGROUND OF THE INVENTION

### Description of Related Art

The extensive interest in graphene associated with its unique hexagonal atomic layer structure and extraordinary properties, including the highest intrinsic career mobility at room temperature of all known materials, is motivated by the development of new composite materials for nano-electronics, super capacitors, batteries, photovoltaics, and related devices. Other properties of graphene, such as the high thermal, chemical and mechanical stability and high surface area also represent desirable characteristics as a 2D catalyst support for metallic and bimetallic nano-particles for variety of applications in heterogeneous catalysis, sensors, hydrogen storage and energy conversion.

Recent advances in the production of graphene through the reduction of exfoliated graphene oxide (“GO”) have provided competent approaches for the large-scale production of graphene. Well known chemical reduction methods also suffer from the difficulties of controlling the reduction process and residual contamination by the chemical reduction agents. This can cause a detrimental effect, particularly for electronic applications of graphene. Therefore, there is a need for developing deoxygenation/reduction methods that do not rely on the use of chemicals or high temperatures. Chemical vapor deposition (“CVD”) methods are also known to produce graphene thin films. However, CVD methods are expensive and do not yield a high amount graphene production. Recently, a flash reduction process was reported for the oxygenation of GO films by photo-thermal heating with camera flash strobes. However, the method does not provide a satisfactory solution for the synthesis of graphene because it only applies to thin dry films of GO. Similarly, femtosecond laser pulses have been used for imprinting and patterning of 55 nm thick GO films, which reduced a depth of 35-25 nm, but the laser reduction process of individual GO sheets dispersed in water has not been demonstrated.

Accordingly, there is an ongoing need in the art to provide improved, varied, and efficient methods for producing graphene and supported nano-particle analysis; such a need has heretofore remained unsatisfied.

### SUMMARY OF THE INVENTION

The present disclosure is directed to a method of synthesis of monolayer, bi-layer, and multi-layer graphene composite by pyrolysis of solid carbon precursor. This methodology is used to synthesize a solid carbon source under an un-oxidizing environment. The method is economical and environmentally friendly, and can produce high quality graphene in large quantities at a low cost in commercial production. The graphene nano-particles formed by the present invention are substantially free of residual defects.

The foregoing, and other features and advantages of the invention, will be apparent from the following, more particular description of various exemplary embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a graph of resistivity values for pyrolysis product of exemplary embodiments with respect to preparation time;

FIG. 2 is a graph of Raman of graphene (30 min deposited) product with D-peak, G-Peak and 2D-peaks;

FIG. 3 is a graph of Raman of graphene (45 min deposited) for product with D-peak, G-Peak and 2D-peaks;

FIG. 4 is a graph of Raman of graphene (60 min deposited) for product with D-peak, G-Peak and 2D-peaks;

FIG. 5 is a graph of Raman spectra of the original (90 min deposited) graphene sample, the with d-peak-peak and 2D band peaks;

FIG. 6A is a FE-SEM image of an exemplary graphene nano-particle product according to an exemplary embodiment;

FIG. 6B is a FE-SEM image of an exemplary graphene nano-particle product according to an exemplary embodiment;

FIG. 7A is a TEM image of an exemplary pyrolysis mono layer graphene product;

FIG. 7B is a TEM image of an exemplary pyrolysis bi-layer and graphene product;

FIG. 7C is a TEM image of three layers graphene product;

FIG. 7D is a TEM image of four layers graphene product;

FIG. 7E is a TEM image of seven layers graphene product;

FIG. 7F is a TEM image of twelve layers graphene product; and

FIG. 8 is a flow chart of an exemplary embodiment of the method of the present invention.

### DETAILED DESCRIPTION OF EXEMPLARY EMBODIMENTS

The following is a glossary of terms as used and contained herein:

Pyrolyze—an exemplary process by which compositions are decomposed through heating to a specified temperature;

Furnace—an exemplary device capable of maintaining a vacuum, heating objects therein to at least 1100° C. within a specified time period, and passing a specified gas over objects therein;

Source Carbon Solids—an exemplary material derived from organic material containing carbon; and

Sonicate—an exemplary process wherein compounds or mixtures are separated by subjecting a sample to ultrasonic vibration.

Methods of producing monolayer, bi-layer and multi-layer graphene and graphene nano-particles prepared by pyrolysis of solid carbon precursor are disclosed herein.

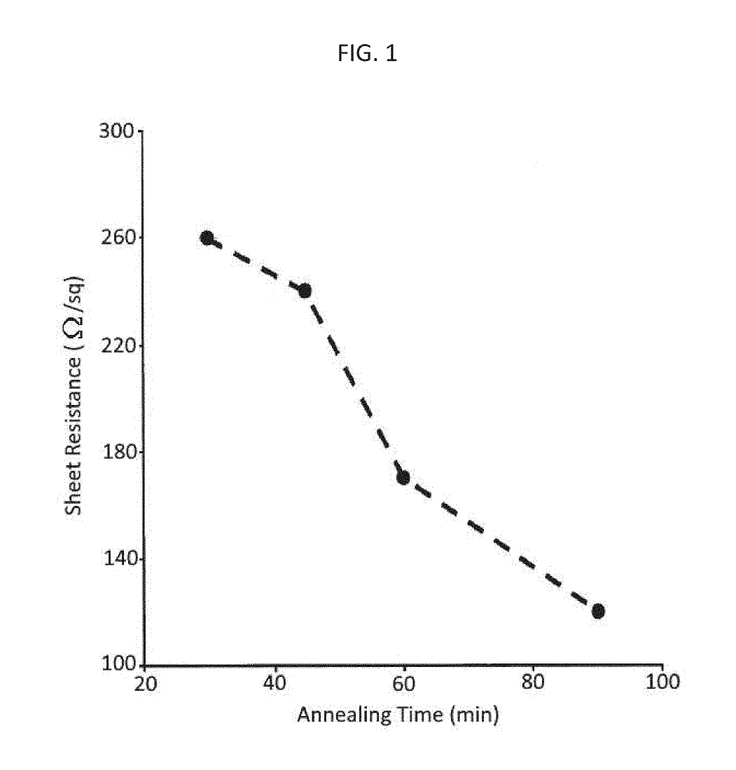

Preferred embodiments of the present invention and their advantages may be understood by referring to FIGS. 1-8, wherein like reference numerals refer to like elements.

The present invention relates to a novel and efficient way to produce large-scale quantities of certain types of graphene in an economically friendly manner. To achieve the goals of the invention, certain exemplary solid plant carbon precursors can provide a system that includes hybrid composites. A hybrid composite may be nano-carbon and a single layer, bi-layer, and multi-layer graphene produced by the solid carbon source under an un-oxidizing environment. When analyzed by Raman spectrometry, scanning electron microscopy (“SEM”), high-resolution transmission electron microscopy (“HR-TEM”) and X-Ray diffraction, the graphene composite, Raman D-peak, G-peak and 2D-peak are approximately 1320 nm, 1620 nm, and 2700, respectively, that form the peaks where it is clearly known that the result is monolayer, bi-layer and multi-layer graphene. Energy-dispersive X-ray spectroscopy (“EDX”) analysis shows peaks at 26.5 degrees, approximately 42.5 degrees, and/or 54.5 degrees.

A hybrid graphene nano-powder and nano-flakes can be produced from the solid carbon source under un-oxidizing environment using a specific NaCl/Fe and/or salt related catalyst. The hybrid is characterized by Raman, SEM, Transmission Electron Microscopy (“TEM”) and EDX that gives different peaks and values at different points. The hybrid composite exhibits relatively high electrical conductivity and enhanced compatibility with various types of material products as well as single layer, bi-layer and multi-layer graphene products. The graphene composite exhibits high electrical conductivity and enhanced mobility with various types of materials as well as comprising nano-carbon and pure single-layer, bi-layer and multi-layers graphene. The hybrid composite is effective for electron production catalyst, electro conductive applications such as conductive paintings and lacquer, electromagnetic shielding, conductive inks, electro conducive mechanical processing such as bipolar plates, hydrogen fuel cells, bio sensors, glucose meters, and/or alcohol detect, etc.

Carbon has four unique crystalline structures, including diamond, graphite, fullerene, and carbon nanotubes. Graphene is an allotrope of carbon whose structure comprises substantially a one-atom-thick planar sheet of sp2-bonded carbon atoms packed in a honeycomb crystal lattice. Graphene is visible as an atomic scale sheet made of carbon atoms and their bonds. The crystalline or flake form of graphite contains of many graphene sheets stacked together.

Bi-layer graphene can be found either in twisted configurations where the two layers are intertwined relative to each other or graphitic Bernal stacked configurations where half of the atoms in one layer lie atop half the atoms in the other.

Graphene nano-particles comprise a stack of monolayer, bi-layer and multi-layer graphene. In each layer, the carbon atoms are arranged in a hexagonal lattice with separation of approximately 0.142 nanometers (“nm”), and the distance between planners is approximately 0.335 nm. Two forms of graphite, alpha (hexagonal) and beta (rhombohedral), have very similar physical properties, except the graphene layers stack slightly differently. The hexagonal graphite can be either flat or buckled. The alpha form can be converted to the beta form though mechanical treatment and the beta form can revert to the alpha form when it is heated above approximately 1300° Celsius.

In an exemplary embodiment of the present disclosure, graphene can be made using CVD by using methane and acetylene (carbon source gas) to grow graphene on thin films made from metals such as copper, nickel, and aluminum. In another exemplary embodiment, the present disclosure provides a process of making graphene nanoribbons in which graphene is twisted into nanoribbons. In another exemplary embodiment, these materials can be characterized by one or more drawbacks of poor dispersion, insufficient electron conductivity, limited compatibility with other materials for development of comparison for new applications, and/or high cost material manufacturing requiring plasma CVD reactor of gas phase materials.

In another exemplary embodiment of the present disclosure, a type of nano-carbon of powder shape single layer, multi-layer and few layer graphene may be prepared by the pyrolysis of solid carbon sources using a catalyst comprising sodium, potassium and iron relatives. According to the effect of the sodium related catalyst temperature variation and the amount of the catalyst, a solid carbon source provides several products having different properties. Certain exemplary embodiments utilize an iron-related catalyst to convert a solid carbon source into graphene or graphene powder with an increase to relatively good conductivity greater than, and gives rise to, the graphene products.

In another exemplary embodiment of the present disclosure, carbon nano-tubes (“CNT”) refers to a tubular honeycomb carbon structure, which can be grown by rolling one or more graphene sheets to form a concentric hollow structure. In one embodiment, a graphene sheet comprises carbon atoms occupying a two-dimensional hexagonal lattice, dispersing oxidize and chemically proceed graphite in water, and using paper making techniques, substantially monolayer flakes can form a single sheet and bond. Such sheets, referred to as “graphene oxide paper,” can have measured tensile modes of approximately 32 Gigapascals (GPa). Chemical properties of graphite oxide can be related to functional groups attached to graphene sheets. The functional groups can change a pathway of polymerization and similar chemical processes, and graphene oxide flakes in polymers can enhance photo-conducting properties, as compared to polymers lacking flakes.

In another exemplary embodiment of the present disclosure, graphene products may be constructed from solid carbon source options already existing in nature including tree woods, bees, cottons, and agricultural products such as paddy husks, etc. Such solid carbon sources may be used alone or with certain types of chemicals having the functionality of forming graphene. These chemicals are referenced to as tube control agents (“TCA”). The TCA molecules usually contain carbonatite (“CN”) functional groups, and examples of TCA include tree lignin, phthalic nitride, and other derivatives.

In another exemplary embodiment of the present disclosure, salt grindings of any salt (for example, NaCl, NaI, NaF, NaBr, Na2CO3) or inorganic salt may be used. The salt milling process may be done with any device having grinding, mixing and/or blending capabilities. In another exemplary embodiment of the present disclosure, the milling process may be performed with different milling media instead of, or in addition to, salt, such as glass beads, plastic beads, ceramic beds, and metallic solid carbon sources. The process is initiated by washing the milled solid carbon with a solvent, such as tap water, deionized water, seawater, hot or cold water, and/or any solvents capable of dissolving the salts that serve as effective agents for washing.

In another exemplary embodiment of the present disclosure, graphene products may be made by a process wherein the first step involves mixing a solid carbon source with a catalyst. In one embodiment, the solid carbon precursor may be obtained from plant solids. In such an embodiment, the plant solids are ground into particles having an approximate diameter of less than 1.0 mm. In another exemplary embodiment, the carbon solids are mixed with approximately 10 grams of NaCl2.6H2O that is substantially dissolved in a container containing approximately 100 grams of deionized water. The solid carbons are slowly added into the solution of sodium salt and stirred at a temperature of approximately 80° C. to 90° C. until the water is evaporated. In one embodiment, the solution may be stirred for up to 48 hours. Once substantially all of the deionized water has evaporated from the solution, the remaining solid is a graphene precursor.

In another exemplary embodiment of the present disclosure, graphene products may be made by a process wherein the second step comprises pyrolizing the graphene precursor. In one embodiment, the graphene precursor is transferred to a vacuum quartz tube and heated it to approximately 1100° C. to 1300° C. for approximately 30 to 90 minutes. In one embodiment, hydrogen gas is used in the pyrolizing process. In another embodiment, a gas comprising a mixture of hydrogen and nitrogen is used during the pyrolizing process. In another embodiment, after substantially all of the oxygen has been drawn out of the graphene precursor, the heat source is removed and the material left in the quartz tube is allowed to cool to room temperature. The resulting material, which has been separated out and which will be referred to herein as raw graphene, is collected and ground and washed in solution. In one embodiment, the washing solution comprises HCl at a concentration of approximately 6 Molar with 1:10 ratio of the raw graphene to HCl. HCl is used to wash the raw graphene by stirring for approximately twenty four hours at room temperature. In one embodiment, the washing solution is filtered and the residue is collected and washed again for two more times to remove any remaining catalyst before it is dried in an oven at approximately 80° C. for twenty four hours. After the residue product is dried, graphene of a purer concentration results as compared with that prior to removal of the catalyst and drying in the oven.

In another exemplary embodiment of the present disclosure, the present invention provides a method for creating nano-carbon products comprising graphene nano-particles. In such an embodiment, the graphene nano-particles produced may be utilized in many applications including conductive paint, conductive lacquer, electromagnetic shielding, conductive ink, adapted for use in printing electronics, a conductor and/or transparent conductor adapted for use in a light emitting diode, a solar cell, an electrical conductor adapted for using a battery electrode, an electrical conductor, a bipolar plate adapted for use in a fuel cell, an electro catalyst adapted for use in fuel cell, a photo conductor, a transistor, a charge transport element or charge generation element adapted for use in a solar cell, photoconductor, a transistor a bio sensor or glucose mater and alcohol detector. In another embodiment, the hybrid composite may comprise tubular carbon and graphene products made from pyrolysis of milled solid carbon sources in an under un-oxidizing environment.

In another exemplary embodiment of the present disclosure and with reference to FIG. 1, sheet resistance values vary with respect to annealing duration. The values of graphene product in accordance with annealing time, at increasing annealing times, FIG. 1 illustrates the effect on sheet resistance at constant thickness of spin-coated graphene nano powder products. The result shows decreasing sheet resistance value with increasing annealing duration from 30 to 90 minutes.

Raman spectrometry is widely used in the art as a technique to characterize the structural and electrical properties of graphene, including disorder and defect structures. The Raman structure of graphene is characterized by three main features, the G-mode arising from emission of zone center optical phonons (usually absorbed around 1575 cm-1), D-mode arising from the doubly resonant disorder, included mode (usually absorbed around 1350 cm-1), and the symmetry allowed 2D overtone mode (usually absorbed around 2700 cm-1). The shift and the line shape associated with these modes are used to distinguish single and free-signed graphene sheets for bi-layer and multi-layer graphene sheets, as measured by the Raman spectra of the original graphene powder.

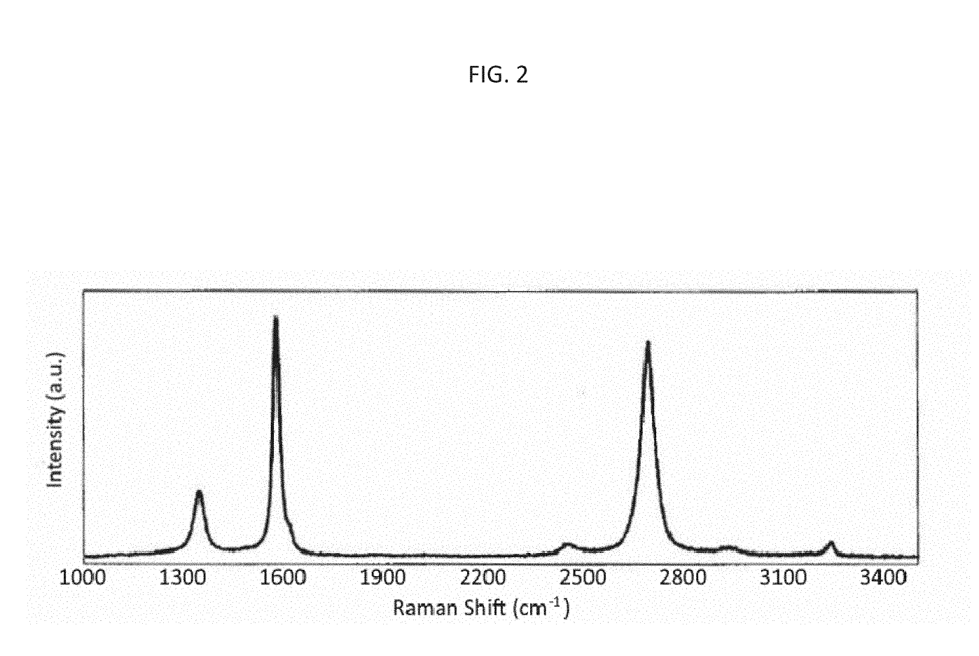

In another exemplary embodiment of the present disclosure and with reference to FIG. 2, the properties of graphene produced using exemplary methods described herein vary with annealing time. In an embodiment, graphene precursor is placed in a furnace and heated to a temperature of approximately 1195° C. Once the furnace reaches the desired temperature, the graphene precursor is maintained at that temperature and annealed for a specified duration. As a result of such an embodiment, the Raman spectroscopy results are displayed employing an annealing time of 30 minutes.

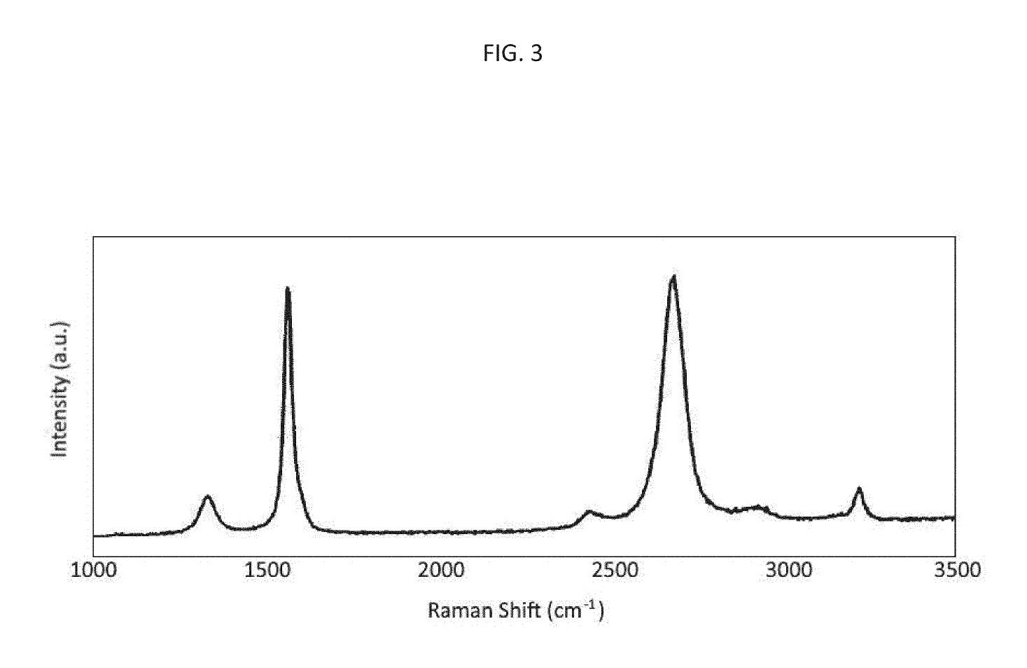

In another exemplary embodiment of the present disclosure and with reference to FIG. 3, the properties of graphene produced using exemplary methods described herein vary with annealing time. In an embodiment, graphene precursor is placed in a furnace and heated to a temperature of approximately 1195° C. Once the furnace reaches the desired temperature, the graphene precursor is maintained at that temperature and annealed for a specified duration. As a result of such an embodiment, the Raman spectroscopy results are displayed employing an annealing time of 45 minutes.

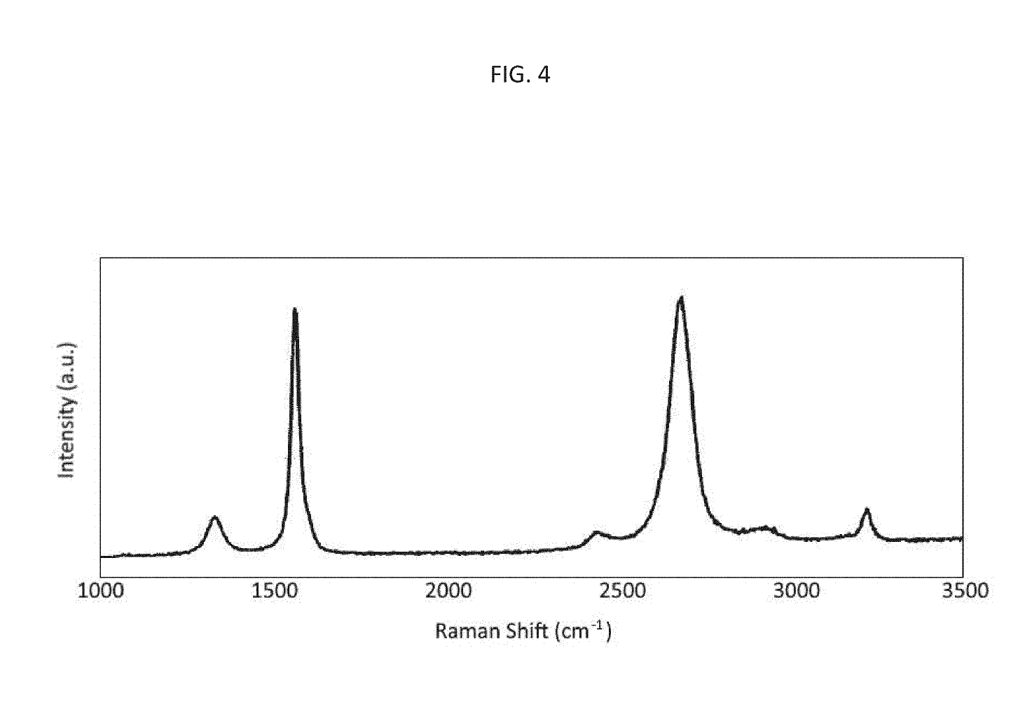

In another exemplary embodiment of the present disclosure and with reference to FIG. 4, the properties of graphene produced using exemplary methods described herein vary with annealing time. In an embodiment, graphene precursor is placed in a furnace and heated to a temperature of approximately 1195° C. Once the furnace reaches the desired temperature, the graphene precursor is maintained at that temperature and annealed for a specified duration. As a result of such an embodiment, the Raman spectroscopy results are displayed employing an annealing time of 60 minutes.

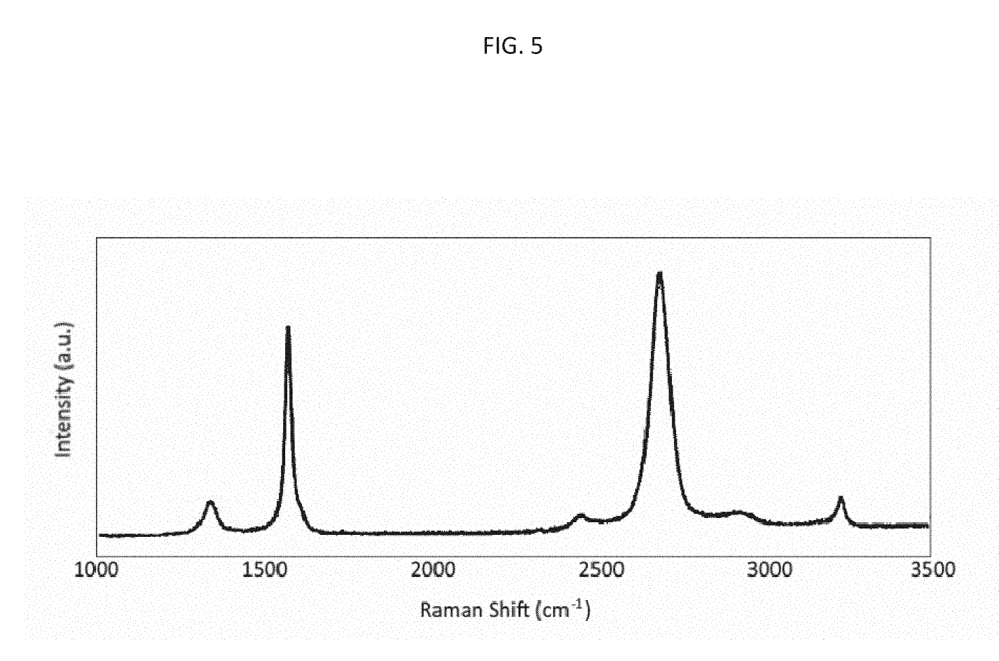

In another exemplary embodiment of the present disclosure and with reference to FIG. 5, the properties of graphene produced using exemplary methods described herein vary with annealing time. In an embodiment, graphene precursor is placed in a furnace and heated to a temperature of approximately 1195° C. Once the furnace reaches the desired temperature, the graphene precursor is maintained at that temperature and annealed for a specified duration. As a result of such an embodiment, the Raman spectroscopy results are displayed employing an annealing time of 90 minutes.

In another exemplary embodiment of the present disclosure, a graphene lattice resulting from the present invention exhibit a Raman shift of 1575 cm-1 (G-band) and the D-band with low intensity at 1354 cm-1. The graphene lattice also exhibits a spectrum having a strong G-band at around 1571 cm-1 and the weak D band around 1357 cm-1 at a defect site. The D-band to the G-band is used as a measure of a quality of the graphitic structure science. Typically, this ratio for highly ordered pyrolytic graphite approaches zero. As shown in the Raman spectra of the graphene nano-particles, the particles exhibit the weak disorder induced D-band with the D to G intensity ratio indicating the high quality of the synthesized graphene powder. Notably, the frequency of the G-mode in the synthesized graphene powder at 1571 cm-1 is very similar to that of absorbed graphite powder at approximately 1575 cm-1. The same trend has been found in the frequency of the G-mode of the freestanding graphene layer, which is appreciably downshifted as compared with that of the supported layer. The overall features of the G-band observed in the graphene nano-particle sheets resulting from the present disclosure are consistent with the Raman spectra in FIGS. 2-5.

The absorbed high-energy second order 2D band of synthesized graphene sheet is approximately 2700 cm-1. The position and shape of 2D peak depends on the number of graphene layers, and therefore the 2D peak, can be used to distinguish between single layer, bi-layer, and multi-layer graphene. Since the synthesized graphene sample shows a single 2D band around 2720 cm-1, it can be concluded that the reason of sample consisted of a product with 1-12 or more layers.

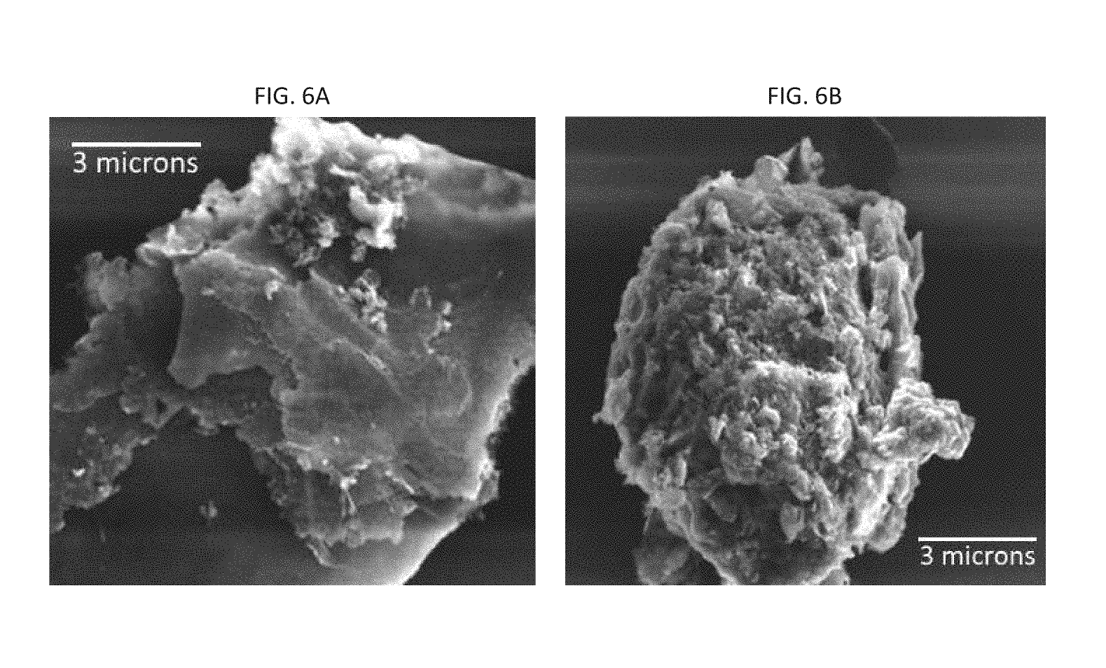

In another exemplary embodiment of the present disclosure and with reference to FIGS. 6A and 6B, an exemplary TEM image of an exemplary graphene nano-particle, where the formation of nano-particles was confined by comprising X-ray Diffraction (“XRD”) pattern, is shown. The diffraction pattern of the nano-particle shows not only a single layer graphene, but also multi-layer graphene, with 98% carbon content.

In another exemplary embodiment of the present disclosure and with reference to FIG. 6A, the present disclosure may result in particular configurations of graphene products. For example, FIG. 6A displays an exemplary embodiment of a scanning electron microscopic (“SEM”) image of an exemplary graphene nano-particle obtained by the method described herein. In such an embodiment, the obtained graphene nano-particle was produced with a potassium catalyst and comprises a particle size of approximately 2 to 9 micrometers in diameter. Further, the figure shows substantially grain-shaped graphene nano-particles and/or graphene powder is produced.

In another exemplary embodiment of the present disclosure, FIG. 6B is an exemplary SEM image of a graphene nano-particle produced by a method described herein. The obtained graphene nano-particle, slightly different than FIG. 6A, may be obtained with using a potassium catalyst and may yield a particle size of about 2-9 micrometers in diameter. Notably, graphene nano-particle having a substantially different shape were produced.

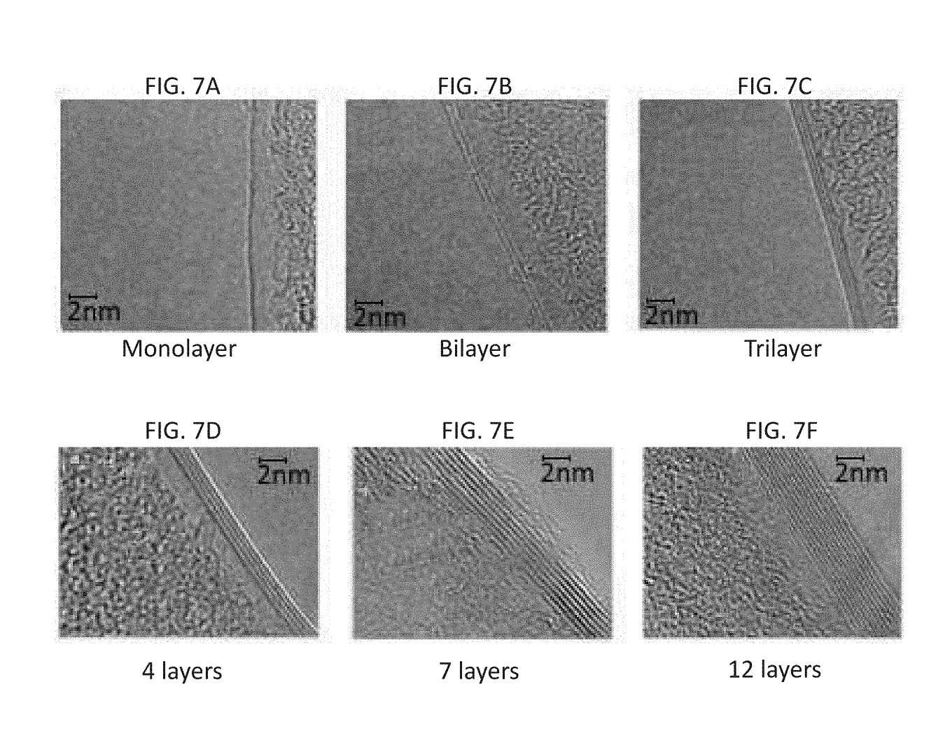

In another exemplary embodiment of the present disclosure and with reference to FIG. 6 and FIG. 7, typical SEM and TEM images of the synthesized graphene sheet by pyrolysis of solid carbon precursor are displayed. The micrographs show extended sheets of lateral dimension ranging from a few microns to twelve micrometers in length with layered structures. The TEM images show a few stacked layers, e.g., 1-4 layers, with a lateral size up to few micrometers. Also, the TEM image shows that some of the graphene layers are folded on the edge with isolated small fragments on the surface.

In another exemplary embodiment of the present disclosure, FIG. 7A is an image produced from a High Resolution Transmission Electron Microscope (“HR-TEM”) of a graphene nano-particle product prepared with an annealing time of 90 minutes using exemplary methods as described herein. In such an embodiment, the nano-particle product comprises approximately 1-4 layers. The distance between the layers is approximately 0.35 nm and the layers obtained from the nano-particles are graphene.

In another exemplary embodiment of the present disclosure, FIG. 7B is an HR-TEM image of a graphene nano-particle product prepared using an annealing time of 60 minutes using exemplary methods as described herein. In such an embodiment, the nano-particle product comprises approximately 3-6 layers as shown. The distance between layers is approximately 0.33 nm and the layers obtained of the nano-particles are graphene.

In another exemplary embodiment of the present disclosure, FIG. 7C is an HR-TEM image of graphene nano-particles made using 45 minutes of annealing and exemplary methods described herein. In an embodiment, the heated precursor was formed with a sodium catalyst and the nano powder comprises approximately 4-8 layers of graphene. The product is graphene as shown by the graphene layers at a distance of approximately 0.33 nm.

In another embodiment of the present disclosure, FIG. 7D is an HR-TEM image of a graphene nano-particle product prepared using exemplary methods described herein, at a 45-minute heating period for the precursor. The nano-particles product has approximately 4-8 graphene layers as seen in FIG. 7D. The distance between layers is approximately 0.35 nm, and the obtained layers of the nano-particles are graphene.

In another embodiment of the present disclosure, FIG. 7E is an HR-TEM image of a graphene nano-particle product prepared using exemplary methods described herein, at a 30-minute heating period for the precursor. In an embodiment, the nano-particle product comprises approximately 5-12 graphene layers. The distance between layers is approximately 0.33 nm and the obtained layers of the nano-particles are graphene.

In another embodiment of the present disclosure, FIG. 7F is an HR-TEM image of a graphene nano-particle product prepared using exemplary methods described herein and a 30-minute heating period for the precursor. The nano-particles product comprises approximately 12 graphene layers. The distance between layers is approximately 0.33 nm and the obtained layers of the nano-particles are graphene.

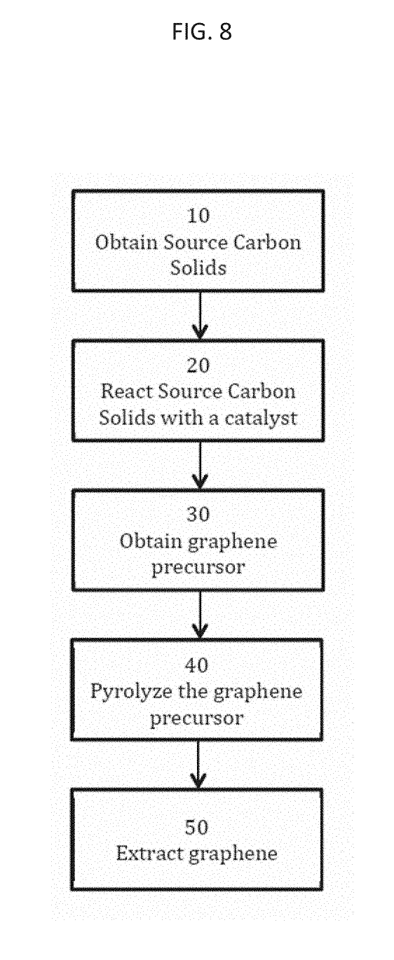

In another exemplary embodiment of the present disclosure and with reference to FIG. 8, graphene may be made using a method described herein. In one embodiment of the present disclosure and with reference to FIG. 8, at step 10, source carbon solids may be obtained from an organic source. In one embodiment, the solid carbon source may be obtained from one or more plant products such as stearic acid, beans, cotton, paddy husks, coconut shells, etc. The solid carbon source may be ground to a particular size by using a grinding technique, such as slot use grinding the solid carbon source. In another embodiment, the ground carbon solids may be sifted using a sifter with specific sized holes, through which carbon solids exhibiting desired dimensions may fall.

In another exemplary embodiment of the present disclosure and with reference to FIG. 8, at step 20, the Source Carbon Solids are reacted with a catalyst. In one embodiment, the Source Carbon Solids, having been reduced to a desired size, may be mixed with deionized water to create a solution. In another embodiment, the catalyst is reacted with the Source Carbon Solids by mixing the catalyst into the Source Carbon Solids and water slurry. In one embodiment, for example, the catalyst comprises at least one component containing iron relatives or a combination of iron relatives comprising a plurality of metal components may be used. In one embodiment, the catalyst may contain NaCl and FeCl2.4H2O.

In another exemplary embodiment of the present disclosure and with reference to FIG. 8, at step 30, graphene precursor is obtained by removing substantially all of the water from the mixture comprising Source Carbon Solids, the catalyst, and deionized water. In one embodiment, the slurry is heat to a temperature of at least approximately 75° C. and stirred for approximately 24 to 48 hours.

In another exemplary embodiment of the present disclosure and with reference to FIG. 8, at step 40, the graphene precursor may be pyrolyzed. In certain exemplary embodiments, the graphene precursor resulting from reacting Source Carbon Solids with a catalyst may be pyrolyzed in a furnace. In one embodiment, the furnace comprises an un-oxidizing environment, promoting the removal of oxygen from the graphene precursor. In one embodiment, the graphene precursor is heated in glass tube using an exemplary pyrolysis method, wherein a furnace containing the glass tube is heated, through which hydrogen gas is passed through the glass tube. In another embodiment, a vacuum is created within the glass tube placed in the furnace. In another embodiment, a gas mixture comprising nitrogen is applied to the graphene precursor once a desired vacuum pressure is reached. In another embodiment, the gas applied to the graphene precursor is passed though the furnace at a specified flow rate. In another embodiment, a gas comprising-nitrogen is used to pyrolyze the graphene precursor.

In another exemplary embodiment of the present disclosure, a hybrid composite comprising graphene and carbon structures are made. In such an embodiment, the catalyst may be adapted, when presented with milled solid carbon sources in pyrolysis using an un-oxidizing environment, to produce a hybrid composite of carbon and graphene. In another exemplary embodiment, the hybrid composite may comprise tubular carbon and graphene nano-particles. In another exemplary embodiment, tubular carbon may comprise carbon nanotubes, carbon nanofibers, carbon nano-rods, or other carbon and graphene composites. The hybrid composite may be produced using pyrolysis of milled solid carbon source in an un-oxidizing environment.

In another exemplary embodiment of the present disclosure and with reference to FIG. 8, at step 50, graphene is extracted from the pyrolyzed graphene precursor. In one embodiment, the pyrolyzed precursor is washed with a solvent. In one embodiment, the solvent may be HCl. The pyrolyzed precursor is washed by placing it into a container, into which the solvent is then added. In another embodiment, the mixture is then stirred at room temperature for approximately 24 hours and is then filtered. The remaining solids are then washed again two more times using the above described process. The washing and filtering process results in the purer graphene as compared with that prior to washing and filtering. In another embodiment, the purer graphene may be mixed with a solution such as acetone and sonicated to obtain graphene dispersion

In another exemplary embodiment of the present disclosure, the pyrolyzed carbon may be used in a variety of applications. For example, a system may be utilized that comprises a hybrid composite. The hybrid composite may comprise graphene nano-particles. The hybrid composite may be present in the system of at least one of: conductive paint, conductive lacquer, electromagnetic shielding, conductive ink adapted for use in printed electronics, a conductor adapted for use in a solar cell, an electrical conductor, bipolar plate adapted for use in fuel cell, an electro catalyst adapted for use in fuel cell, charge transport element or charge generation element adapted for use in a solar cell, a transistor, a biosensor, a glucose mater and alcohol detector.

In another exemplary embodiment of the present disclosure, the hybrid composite may be blended with a solvent, a metal, a ceramic, a plastic, an oxide, a nitride, and/or material comprising carbon.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method for making graphene comprising the steps of:
a. reacting a catalyst with a plurality of source carbon solids;
b. creating a graphene precursor from the reaction of the catalyst with the plurality of source carbon solids;
c. pyrolyzing the graphene precursor; and
d. extracting graphene from the pyrolyzed graphene precursor to obtain extracted graphene.
e. washing the extracted graphene in HCl and filtering to obtain clean and filtered graphene.
f. sonicating the clean and filtered graphene with acetone to obtain graphene dispersion.

2. The method of claim 1, wherein the plurality of source carbon solids are less than or equal to approximately 1.0 mm in any direction.

3. The method of claim 1, wherein the catalyst comprises iron relatives and salt.

4. The method of claim 1, wherein the step of creating a graphene precursor comprises the steps of:
a. creating a solution comprising deionized water and the catalyst;
b. reacting the catalyst with the plurality of source carbon solids by mixing the plurality of source carbon solids into the solution;
c. heating the solution; and
d. stirring the mixture until substantially all liquid has evaporated.

5. The method of claim 4, wherein the solution is heated to a temperature of at least approximately 75° C.

6. The method of claim 4, wherein the solution is stirred for approximately 24 to 48 hours.

7. The method of claim 1, wherein pyrolyzing the graphene precursor comprises the steps of:
a. placing the graphene precursor in a furnace;
b. creating a vacuum within the furnace;
c. passing a gas through the furnace once vacuum pressure is reached;
d. heating the furnace to at least approximately 1100° C.; and
e. annealing the graphene precursor in the furnace.

8. The method of claim 7, wherein the vacuum created within the furnace is at least approximately −0.1 MPa before allowing gas to pass through at a desired flow rate.

9. The method of claim 7, wherein the gas comprises nitrogen.

10. The method of claim 7, wherein the graphene precursor is annealed for at least approximately 20 minutes.

11. The method of claim 1, wherein extracting graphene comprises the steps of:
a. washing the pyrolyzed graphene precursor in a solvent followed by filtering the solvent;
b. collecting graphene, after the step of washing the pyrolyzed graphene precursor in the solvent followed by filtering the solvent, to result in collected graphene;
c. drying the collected graphene to produce a dry graphene;
d. sonicating the dry graphene to obtain graphene dispersion.

12. The method of claim 11, wherein the solvent comprises HCl.

13. The method of claim 12, wherein extracting graphene further comprises filtering the pyrolyzed graphene and HCl solvent to remove HCl.

14. The method of claim 12, wherein the dry graphene is achieved by drying in oven at 80 degrees Celsius to obtain graphene powder.

15. The method of claim 14, wherein the graphene powder is mixed with acetone and sonicated for four hours to obtained graphene dispersion.
